(19) United States
(12) Patent Application Publication
(10) Pub. No.: US 2024/0419313 A1
(43) Pub. Date: Dec. 19, 2024

(54) COMMUNICATION SYSTEM

(71) Applicant: YAZAKI CORPORATION, Tokyo (JP)

(72) Inventors: Takeshi Ishikawa, Makinohara-shi (JP); Yuki Ebata, Makinohara-shi (JP); Eri Moriyama, Makinohara-shi (JP)

(21) Appl. No.: 18/814,433

(22) Filed: Aug. 23, 2024

Related U.S. Application Data
(63) Continuation of application No. PCT/JP2023/011667, filed on Mar. 23, 2023.

(30) Foreign Application Priority Data
Mar. 28, 2022 (JP) 2022-052163

(51) Int. Cl. G06F 3/04845; G06Q 10/101; H04N 7/15

(52) U.S. Cl. CPC G06F 3/04845; G06Q 10/101; H04N 7/157

(57) ABSTRACT

A VR conferencing system includes a projection unit and a display unit capable of communicating with the projection unit. The projection unit includes a VR goggle that displays a stereoscopic image edited in accordance with a user operation in a virtual realty space. The display unit includes a two-dimensional display that displays a field of view by the VR goggle, and a user operation unit that receives designation of a position on a screen of the two-dimensional display. The VR goggle displays a dart pointer at a position in the virtual reality space corresponding to the position.

### CROSS-REFERENCE TO RELATED APPLICATIONS

This is a continuation of International Application No. PCT/JP2023/011667 filed on Mar. 23, 2023, and claims priority from Japanese Patent Application No. 2022-052163 filed on Mar. 28, 2022, the entire content of which is incorporated herein by reference.

### TECHNICAL FIELD

The present invention relates to a communication system.

### BACKGROUND ART

For example, a cooperative virtual reality online conferencing platform disclosed in Patent Literature 1 shows a technique for replacing a conference on site with a conference in a common virtual space in virtual reality (VR). The platform includes three-dimensional (3D) point group data defining a virtual space, identifiers of a plurality of conference participants, and conference data including positions of a plurality of avatars corresponding to the conference participants in a virtual space. Further, the platform includes a processor that executes an instruction to start an online conference of the plurality of conference participants. A step of starting the online conference includes a step of providing an address of a 3D point group to each conference participant, and a step of transmitting 3D point group data and conference data to each conference participant. A current place of each avatar in the virtual space is transmitted to all the conference participants.

In the specification of Patent Literature 1, the “online conferencing platform” means a conference in which participants at different geographical places view the same computer screen while speaking via a voice line. The plurality of persons in charge are located in the respective offices, and can participate at separate places (represented by scan data) in the VR.

### CITATION LIST

### Patent Literature

Patent Literature 1: JP2019-82997A

### SUMMARY OF INVENTION

When a company or the like develops various products, it may be preferable that a plurality of persons in charge who are present at a plurality of sites of the same company or a related company simultaneously gather at the same place, and examine a specific product.

For example, when a product of a wire harness to be mounted on a vehicle is newly developed or a specification of an existing product is changed, a routing path, a shape, and the like of the wire harness are determined by a vehicle manufacturer, and a design drawing is created. At this time, the vehicle manufacturer needs to examine from a viewpoint of the ease of assembly of the wire harness to the vehicle.

Further, based on the design drawing transmitted from the vehicle manufacturer, a component manufacturer has examined from a viewpoint of a component cost, a manufacturing cost, and the like of the wire harness, and has examined from a viewpoint of the ease of manufacturing the wire harness and the like, and creates a design drawing for the component manufacturer.

In the case of individually examining a plurality of independent sites as described above, when a problem is found in the design of the wire harness by the component manufacturer, the problem is transmitted to the vehicle manufacturer, and the vehicle manufacturer re-creates a design drawing in which the problem is corrected. When the component manufacturer receives the modified design drawing from the vehicle manufacturer, the component manufacturer creates a design drawing for the self-company and remanufactures the wire harness again. Accordingly, there is a possibility that a change in specification and the like are repeated many times and a large time loss occurs. In particular, when the person in charge of each company examines the content of a two-dimensional drawing, it is difficult to grasp an actual three-dimensional shape of each part of the wire harness, and it is difficult to find a problematic place.

Therefore, it is conceivable that persons in charge at a plurality of sites, such as a vehicle manufacturer and a component manufacturer, simultaneously gather at the same place, and, for example, persons in charge at all the sites simultaneously examine while viewing an actual model of a wire harness or an actual jig disposed on one work table. Accordingly, the number of times repeating to change a manufacturing specification of the wire harness or the like may be reduced, and the development efficiency may be improved.

For example, when the VR system disclosed in Patent Literature 1 is adopted, even if persons in charge at various sites do not move and gather in one place, three-dimensional shapes of the same product may be simultaneously grasped on screens of different computers. However, during a conference, when a person in charge wants to notify other participants of, for example, a place desired to be examined in detail or a place desired to be corrected, it is difficult to specify the place and transmit the place by speaking, and smooth communication may not be performed.

The present invention has been made in view of the above circumstances, and an object thereof is to enable smooth communication between participants in a conference using a virtual reality space.

The object of the present invention is achieved by the following configuration.

A communication system includes:
a first electronic device; and
a second electronic device capable of communicating with the first electronic device, in which
the first electronic device includes a first display unit that displays an object edited in accordance with a user operation in a virtual reality space,
the second electronic device includes:
   a second display unit configured to display a field of view by the first display unit of the first electronic device; and
   a position designation unit configured to receive designation of a position on a screen of the second display unit, and
the first display unit displays a pointer at a position in the virtual reality space corresponding to the position.

The second electronic device calculates position information of the position received by the position designation unit in the second display unit and transmits the position information to the first electronic device, and
the first electronic device sets a position based on the position information in the virtual reality space as a goal position, sets a position of the first electronic device in the virtual reality space as a start position, and displays, in the virtual reality space, the pointer formed in a dart shape in which a tip is disposed at the goal position along a vector from the stat position toward the goal position.

According to the present invention, it is possible to perform smooth communication between participants of a conference.

The present invention is briefly described above. Details of the present invention can be clarified by reading modes (hereinafter, referred to as “embodiments”) for carrying out the invention to be described below with reference to the accompanying drawings.

### BRIEF DESCRIPTION OF DRAWINGS

FIG. 1 is a schematic diagram showing a situation of an online conference using a virtual reality conferencing system of the present invention;

FIG. 2 is a block diagram showing a configuration example of a VR conferencing system;

FIG. 3 is a block diagram showing a configuration example of a conferencing management server and a projection unit;

FIG. 4 is a diagram illustrating a dart pointer display process;

FIG. 5 is a diagram illustrating a dart pointer display process; and

FIG. 6 is a diagram illustrating a dart pointer display process.

### DESCRIPTION OF EMBODIMENTS

A specific embodiment of the present invention will be described below with reference to the drawings.

### <Situation of Online Conference>

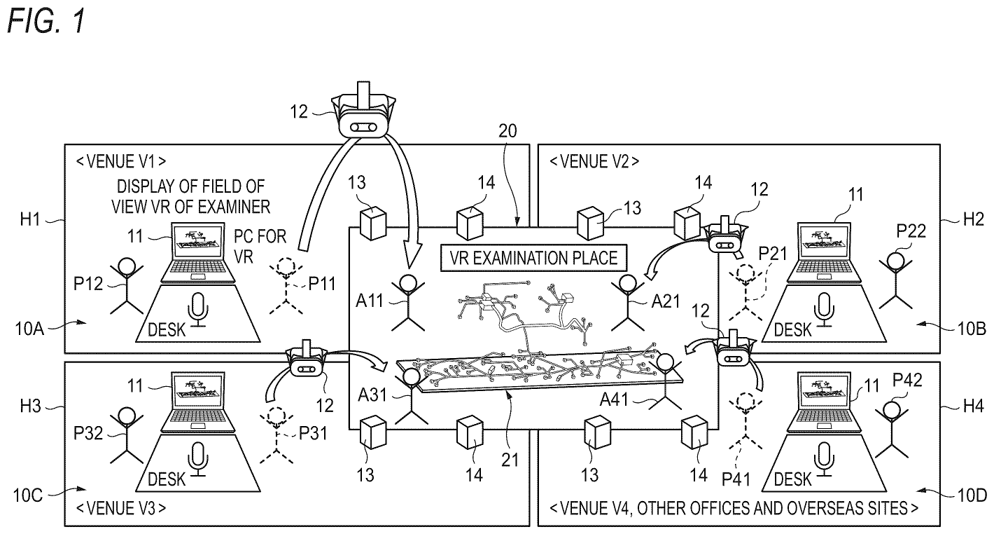

FIG. 1 is a schematic diagram showing a situation of an online conference using a virtual reality conferencing system of the present invention. The virtual reality conferencing system is an example of a communication system.

For example, when a product of a wire harness to be mounted on an automobile is developed, first, a vehicle manufacturer creates a design drawing, and a component manufacturer of a wire harness or the like re-creates a design drawing suitable for manufacturing a wire harness based on the design drawing. However, when a problem occurs in a case where a wire harness manufactured based on the design drawing created by the component manufacturer is routed in the vehicle, the information is transmitted to the vehicle manufacturer, the vehicle manufacturer re-creates the design drawing, and the component manufacturer re-creates a design drawing for the company itself based on the design drawing. Therefore, the design is redone at each site every time a defect occurs, the efficiency of product development decreases.

In order to improve the efficiency of product development, persons in charge who belong to, for example, a design site in a company group that provides a product of a wire harness, a manufacturing site in Japan, a manufacturing site in foreign countries, and a design site of an automobile company that manufactures a vehicle equipped with a manufactured wire harness simultaneously participate in the same conference and examine the product.

Here, when a product of a wire harness is developed, it is necessary to appropriately determine a three-dimensional shape of each part of the wire harness so as to pass through an appropriate routing path in accordance with a structure of a vehicle body to be mounted and an arrangement state of various electric components. Further, it is necessary to appropriately determine a layout of jigs used when manufacturing the wire harness in accordance with the three-dimensional shape of each part of the wire harness. It is necessary to appropriately determine a manufacturing procedure and the like in consideration of the work efficiency of a manufacturing process of the wire harness. Further, it is necessary to appropriately determine a branch position, an electric wire length, and the like of the wire harness so that a component cost of each electric wire or the like constituting the wire harness can be reduced.

Therefore, a person in charge at each site needs to examine from a unique viewpoint to be considered by each person in charge while grasping the three-dimensional shape of each part of the wire harness to be designed. Therefore, in general, after a real model or the like is prepared, persons in charge at all sites move and gather in the same examination place, and all members examine while viewing the same real model and the like at the same place. Accordingly, the efficiency of the conference can be increased. However, since there are many cases where each site is present at a place separated from each other by a distance such as overseas, a burden such as time and costs required for moving to hold a conference becomes extremely large.

In the case of using the VR conferencing system according to the embodiment, for example, by holding a conference using a VR examination place 20 shown in FIG. 1, an online conference can be held without movement of a person in charge at each site.

In the example shown in FIG. 1, it is assumed that a plurality of persons in charge present in each of the independent four sites H1, H2, H3, and H4 simultaneously gather in the common VR examination place 20 and hold an examination conference. The sites H1, H2, H3, and H4 correspond to, for example, a design site in a company group that provides a product of a wire harness, a manufacturing site in Japan, a manufacturing site in foreign countries, and a design site of an automobile company that manufactures a vehicle equipped with a manufactured wire harness.

There is an actual venue V1 for an examination conference at a specific place in the site H1. Similarly, at a specific place in each of the sites H2, H3, and H4, actual venues V2, V3, and V4 for an examination conference are present.

In the example shown in FIG. 1, one or more examiners P11 and one or more participants P12 are present in the venue V1. Similarly, one or more examiners P21 and one or more participants P22 are present in the venue V2. In addition, one or more examiners P31 and one or more participants P32 are present in the venue V3. One or more examiners P41 and one or more participants P42 are present in the venue V4.

In the venue V1, one or more display units 11, one or more projection units 12, one or more position sensors 13, and 14 are provided as system equipment 10A necessary for the online conference. The projection unit 12 is an example of a first electronic device, and the display unit 11 is an example of a second electronic device.

In the venue V2, one or more display units 11, one or more projection units 12, one or more position sensors 13, and 14 are provided as system equipment 10B. In the venue V3, one or more display units 11, one or more projection units 12, one or more position sensors 13, and 14 are provided as system equipment 10C. In the venue V4, one or more display units 11, one or more projection units 12, one or more position sensors 13, and 14 are provided as the system equipment 10C.

The examiner P11 in the venue V1 who wears the projection unit 12 included in the VR conferencing system can move as an avatar A11 in a virtual reality space of the VR examination place 20, and change a posture of the avatar A11. In addition, the examiner P11 who wears the projection unit 12 can visually recognize a stereoscopic image 21 in the field of view at a position of the avatar A11 as an actually stereoscopically viewed image. The same applies to the examiners P21 to P41 in the other venues V2 to V4. The stereoscopic image 21 is an example of an object.

In practice, a stereoscopic image that can be three-dimensionally recognized can be displayed by providing a parallax between an image shown on the left eye and an image shown on the right eye of the examiner P11 from the projection display using a VR goggle 15 and the like described later.

The VR examination place 20 is a three-dimensional space virtually formed in the processing of a computer, and is formed, for example, as a box-shaped space that is the same as a room of a general conference hall. In the example shown in FIG. 1, the stereoscopic image 21 generated based on design data of a wire harness developed as a product is virtually present in a space of the VR examination place 20. More specifically, a three-dimensional model of the wire harness and a three-dimensional model of a large number of jigs disposed on a work platform used for manufacturing the wire harness are included in the stereoscopic image 21.

In addition, a stereoscopic image of the avatar A11, which is a character (doll or the like) corresponding to the examiner P11 in the venue V1, is disposed in a space of the VR examination place 20. Stereoscopic images of the avatars A21 to A41 corresponding to the respective examiners P21 to P41 in the other venues V2 to V4 are also disposed in the space of the VR examination place 20.

When the examiner P11 moves in a reality space in the venue V1, the position sensors 13 and 14 provided in the venue V1 detect a position change of the examiner P11. An actual three-dimensional position change of the examiner P11 detected by the position sensors 13 and 14 is reflected in a three-dimensional position change of the avatar A11 in the virtual space of the VR examination place 20. Further, an actual posture change of the examiner P11 is detected by the projection unit 12 worn by the examiner P11, and the result is reflected in the posture change of the avatar A11 in the VR examination place 20. The same applies to the examiners P21 to P41 and the avatars A21 to A41 in the other venues V2 to V4.

On the other hand, the display unit 11 disposed in the venue V1 is, for example, a computer including a two-dimensional display such as a notebook computer (PC), and is connected to be able to cooperate with the projection unit 12 in the venue V1. Specifically, an image of the VR examination place 20 in substantially the same range as a video shown in the field of view of the examiner P11 who wears the projection unit 12 in the venue V1 is displayed on a screen of the display unit 11 in a state synchronized with a position and posture of the projection unit 12. Of course, the screen of the display unit 11 is a two-dimensional display, and the stereoscopic image 21 in the VR examination place 20 is converted into a two-dimensional image and displayed on a two-dimensional screen of the display unit 11.

Similarly, the display unit 11 in the venue V2 can display, on the screen of the display unit 11 in the state synchronized with the position and posture of the projection unit 12, an image of the VR examination place 20 in substantially the same range as a video shown in the field of view of the examiner P21 who wears the projection unit 12 in the venue V2. The display unit 11 in the venue V3 can display, on the screen of the display unit 11 in the state synchronized with the position and posture of the projection unit 12, an image of the VR examination place 20 in substantially the same range as a video shown in the field of view of the examiner P31 who wears the projection unit 12 in the venue V3. The display unit 11 in the venue V4 can display, on the screen of the display unit 11 in the state synchronized with the position and posture of the projection unit 12, an image of the VR examination place 20 in substantially the same range as a video shown in the field of view of the examiner P41 who wears the projection unit 12 in the venue V4.

The display units 11 in the respective venues V1 to V4 are disposed on, for example, a desk. A microphone for collecting voice in the same venue and a speaker for voice amplification are also disposed on the same desk.

The examiner P11 in the venue V1 who wears the projection unit 12 can simultaneously move around a virtual space of the VR examination place 20 by moving around the venue V1 in the reality space. That is, an actual movement of the examiner P11 is reflected in a change in a position and a posture viewed by the examiner P11 in the VR examination place 20, and is also reflected in the contents of the field of view of the examiner P11 projected by the projection unit 12. The same applies to the examiners P21 to P41 in the other venues V2 to V4.

By actually moving around, the examiners P11 to P41 in the respective venues V1 to V4 can visually grasp in detail a state such as a three-dimensional shape of a part of a product or a jig to be examined in the VR examination place 20.

Further, since the avatars A11 to A41 corresponding to the examiners P11 to P41 in the respective venues V1 to V4 are present in the VR examination place 20, the examiners P11 to P41 can immediately grasp the positions and the postures, which are viewed by the examiners who are at the other sites, according to the images projected by the own projection unit 12. Therefore, it is easy for a plurality of examiners at different sites to simultaneously confirm and examine the same part of a product in the VR examination place 20.

Each of the participants P12 to P42 other than the examiners P11 to P41 in the respective venues V1 to V4 can also grasp a video of a part examined by the examiners P11 to P41 based on the contents displayed by the display unit 11.

On the other hand, as will be described later, the projection unit 12 at each site includes a user operation unit that receives an input operation of each of the examiners P11 to P41. The display unit 11 at each site also includes a user operation unit that receives an input operation of each of the participants P12 to P42.

Each of the examiners P11 to P41 can add a correction operation such as change, addition, or deletion to data of the stereoscopic image 21 in the VR examination place 20 by operating the user operation unit of the projection unit 12 worn by the examiners P11 to P41. The correction operation by each of the examiners P11 to P41 is recorded as data by the VR conferencing system, and is reflected in the stereoscopic image 21 in real time. As a result of the correction operation performed by any one of the examiners P11 to P41, the projection contents of the projection units 12 of all the examiners P11 to P41 and the display contents of the display units 11 of all the participants P12 to P42 are reflected in real time.

Accordingly, all of the examiners P11 to P41 present at different sites can simultaneously examine while confirming the same stereoscopic image 21 in substantially the same field of view using the common VR examination place 20. In addition, all of the examiners P11 to P41 present at different sites can correct a shape, structure, layout, and the like of the product or jig projected as the stereoscopic image 21 as necessary, and confirm a correction result in real time. In addition, even for the participants P12 to P42 other than the examiners P11 to P41, by referring to a display screen of the display unit 11, it is possible to confirm a two-dimensional image corresponding to the stereoscopic image 21 at substantially the same field of view as that of the examiners P11 to P41 and simultaneously examine the two-dimensional image. Therefore, all participants of the online conference can efficiently perform the examination work. In particular, as will be described later, each of the participants P12 to P42 designates, on the display screen of the display unit 11, a place of interest such as, for example, a place desired to be examined in detail or a place desired to be corrected, and can share the designated place with the other examiners P11 to P41 and the participants P12 to P42. Accordingly, it is possible to perform smooth communication between participants of a conference.

### <Configuration of System>

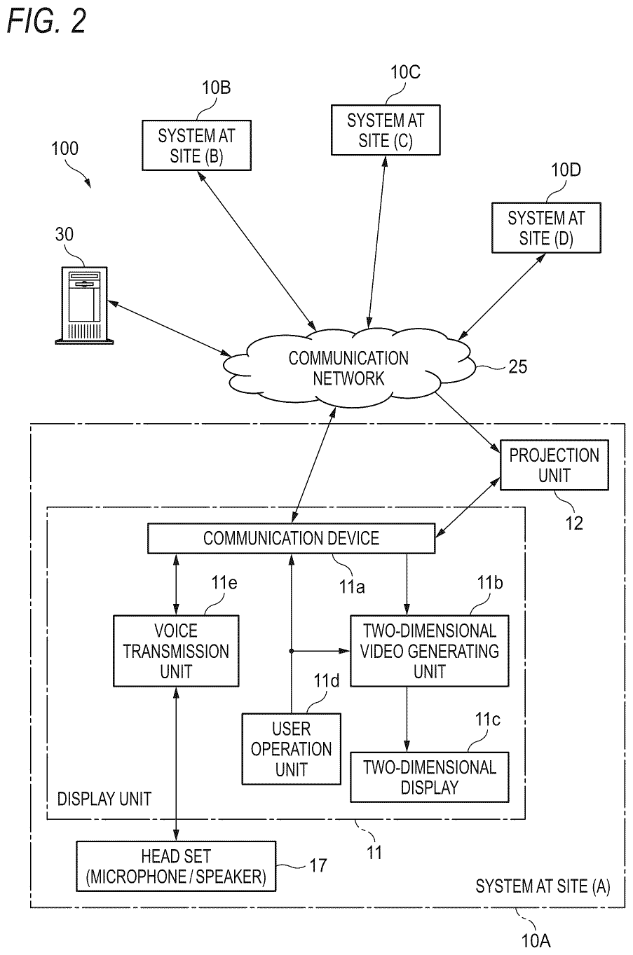

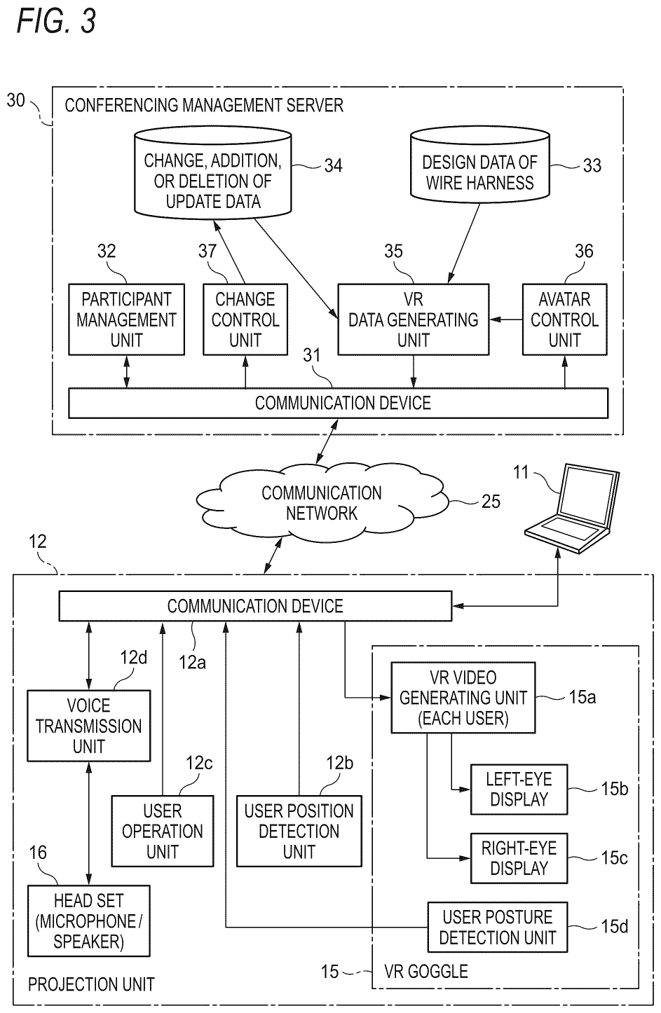

FIG. 2 is a block diagram showing a configuration example of the VR conferencing system 100. FIG. 3 is a block diagram showing a configuration example of a conferencing management server 30 and the projection unit 12.

In the example shown in FIG. 2, the system equipment 10A to 10D existing in the venues V1 to V4 at different sites H1 to H4 are connected to be able to communicate with each other via a communication network 25.

In order to enable simultaneous online conferences at the plurality of sites H1 to H4 using the common VR examination place 20, the conferencing management server 30 is connected to the communication network 25. The communication network 25 is assumed to include a local network existing in each of the sites H1 to H4, a dedicated communication line in a company, or a public communication line such as the Internet.

When the communication of the conference is performed via the Internet, the security of communication can be ensured by encrypting the data. In addition, the conferencing management server 30 may be provided at one place of the plurality of sites H1 to H4 or may be provided at a data center or the like at a place other than the sites H1 to H4.

The conferencing management server 30 shown in FIG. 3 includes a communication device 31, a participant management unit 32, database management units 33 and 34, a VR data generating unit 35, an avatar control unit 36, and a change control unit 37.

The communication device 31 has a function of safely performing data communication with the system equipment 10A to 10D at the respective sites H1 to H4 via the communication network 25.

The participant management unit 32 has a function of managing access to participants who participate in a common online conference with the examiners P11 to P41 or the participants P12 to P42.

The database management unit 33 holds and manages design data corresponding to the wire harness being developed. The design data includes data indicating shapes, dimensions, various components, and the like of parts of a target wire harness, and data indicating shapes and layouts of various jigs used for manufacturing the wire harness.

The database management unit 34 has a function of holding and managing update data indicating a correction portion for data of a specific version held by the database management unit 33. For example, data indicating that a shape of a specific part of the wire harness is changed, data indicating that a new component is added to the specific part of the wire harness, data indicating that a component of the specific part of the wire harness is deleted, and the like are sequentially registered and held in the database management unit 34 during the online conference.

The VR data generating unit 35 generates data of the stereoscopic image 21 disposed in a three-dimensional virtual space of the VR examination place 20. The data of the stereoscopic image 21 generated by the VR data generating unit 35 includes a stereoscopic image corresponding to the design data of the wire harness held by the database management unit 33, a stereoscopic image corresponding to each avatar managed by the avatar control unit 36, and a stereoscopic image corresponding to the update data managed by the database management unit 34.

The avatar control unit 36 has a function of managing, as the avatars A11 to A41, characters in the VR examination place 20 corresponding to the examiners P11 to P41 at the respective sites H1 to H4 who participate in the online conference of the VR conferencing system 100. The avatar control unit 36 has a function of constantly monitoring the position (three-dimensional coordinates) and the posture (direction of the line of sight) of each of the examiners P11 to P41 and grasping a latest state.

The change control unit 37 has a function of receiving, as a correction instruction for the stereoscopic image 21 in the VR examination place 20, an input operation performed by the examiners P11 to P41 at the respective sites H1 to H4 who participate in the online conference of the VR conferencing system 100 to the user operation unit of the projection unit 12 and an input operation performed by the participants P12 to P42 at the respective sites H1 to H4 to a user operation unit of the display unit 11. The change control unit 37 has a function of registering the received correction instruction in the database management unit 34 as update data representing change, addition, deletion, and the like of the stereoscopic image 21.

On the other hand, the projection unit 12 shown in FIG. 3 includes a communication device 12a, a user position detection unit 12b, a user operation unit 12c, a voice transmission unit 12d, the VR goggle 15, and a head set 16. The VR goggle 15 includes functions of a VR video generating unit 15a, a left-eye display 15b, a right-eye display 15c, and a user posture detection unit 15d. The head set 16 incorporates a microphone and a speaker. The VR goggle 15 is an example of a first display unit.

The communication device 12a is connected to the conferencing management server 30 via the communication network 25, and can transmit and receive data to and from the conferencing management server 30. Specifically, the data of the stereoscopic image 21 in the VR examination place 20 is periodically acquired from the conferencing management server 30. The data of the stereoscopic image 21 acquired by the communication device 12a from the conferencing management server 30 includes design data such as a three-dimensional shape and a layout of the jigs of the wire harness and data of a three-dimensional shape, a position, and a posture of each of the avatars A11 to A41.

In addition, for example, the communication device 12a in the projection unit 12 at the site H1 can periodically transmit, to the conferencing management server 30, information on three-dimensional position coordinates of the examiner P11 detected by the position sensors 13 and 14 at the site H1 and the posture (direction of the line of sight) of the examiner P11 detected by the VR goggle 15 worn by the examiner P11.

Further, for example, the communication device 12a in the projection unit 12 at the site H1 is connected to the display unit 11 at the site H1, and it is possible to periodically transmit, to the display unit 11, information indicating a range of the field of view in a virtual reality space of the examiner P11 specified based on the three-dimensional position coordinates of the examiner P11 and the posture of the examiner P11. Further, for example, as will be described later, when a position is designated on the display screen by a mouse operation on the display unit 11 at the site H1, for example, the communication device 12a in the projection unit 12 at the site H1 receives, from the display unit 11, position information of a position designated by the click.

The user position detection unit 12b can detect three-dimensional position coordinates and a change in the three-dimensional position coordinates in a reality space of each of the examiners P11 to P41 based on detection states of a pair of position sensors 13 and 14 disposed at parts facing the examiners P11 to P41 who wear the VR goggle 15 at the respective sites H1 to H4.

The user operation unit 12c is a device capable of receiving various button operations and coordinate input operations by a user, such as a mouse which is a general input device. In the present embodiment, the user operation unit 12c can receive input operations by the examiners P11 to P41 who wear the VR goggle 15 of the projection unit 12. Specifically, the user operation unit 12c can perform a correction instruction such as change, addition, or deletion to the movement or the like of a user designated part in the stereoscopic image 21 of the VR examination place 20 projected from the VR goggle 15.

The voice transmission unit 12d can transmit, to another site via the communication device 12a and the communication network 25, information on voice uttered by an examiner taken in from the microphone of the head set 16. Further, the voice transmission unit 12d can receive information on voice uttered by an examiner at each of the other sites via the communication network 25 and the communication device 12a, and output the information as a voice from the speaker of the head set 16.

The VR goggle 15 have a function of projecting an image that can be three-dimensionally recognized on the left and right eyes of the user who wears the VR goggle 15.

The VR video generating unit 15a constantly recognizes a state of a position and posture (for example, direction of a line of sight) of a user (examiners P11 to P41) in the three-dimensional virtual space of the VR examination place 20, and specifies a range of the field of view of the user. Then, the VR video generating unit 15a acquires, from the conferencing management server 30, at least data in the range of the field of view of the user among the data of the stereoscopic image 21 existing in the three-dimensional virtual space of the VR examination place 20, and generates two types of two-dimensional image data viewed from viewpoint positions of the left and right eyes of the user by coordinate transformation of the data of the stereoscopic image 21.

The left-eye display 15b receives the left-eye two-dimensional image data generated by the VR video generating unit 15a from the VR video generating unit 15a, and projects the left-eye two-dimensional image data to a position of the left eye of the user as a two-dimensional image.

The right-eye display 15c receives the right-eye two-dimensional image data generated by the VR video generating unit 15a from the VR video generating unit 15a, and projects the right-eye two-dimensional image data to a position of the right eye of the user as a two-dimensional image.

The user posture detection unit 15d detects a direction of a line of sight of the user, for example, by tracking positions of the irises of the user captured by a camera or the like. Alternatively, the user posture detection unit 15d detects an angle in a triaxial direction (roll angle, pitch angle, and yaw angle) indicating an orientation of a head of the user using a triaxial acceleration sensor or the like.

The posture of the user detected by the user posture detection unit 15d and the information on the position detected by the user position detection unit 12b are input to the conferencing management server 30 via the communication device 12a and the communication network 25. The position and posture of the user are reflected in the positions and the postures of the corresponding avatar A11 to A41 in the virtual reality space in the VR examination place 20 by a process of the conferencing management server 30.

On the other hand, the display unit 11 shown in FIG. 2 includes a communication device 11a, a two-dimensional video generating unit 11b, a two-dimensional display 11c, a user operation unit 11d, and a voice transmission unit 11e. The two-dimensional display 11c is an example of a second display unit, and the user operation unit 11d is an example of a position designation unit.

The communication device 11a is connected to the conferencing management server 30 via the communication network 25, and can transmit and receive data to and from the conferencing management server 30. Specifically, the data of the stereoscopic image 21 in the VR examination place 20 is periodically acquired from the conferencing management server 30.

The communication device 11a is connected to the projection unit 12 at the same site, and can acquire, from the projection unit 12, information necessary for synchronizing a range of the field of view of an examiner who wears the projection unit 12 and a display range of the display unit 11.

The two-dimensional video generating unit 11b specifies, from the information transmitted from the projection unit 12, the range of the field of view of the examiner who wears the projection unit 12 at the same site, and acquires, from the conferencing management server 30, the data of the stereoscopic image 21 present in the three-dimensional virtual space of the VR examination place 20 in a range equivalent to the field of view of the examiner. Then, the two-dimensional video generating unit 11b generates two-dimensional image data of an image viewed from a viewpoint position of the examiner by coordinate conversion of the data of the stereoscopic image 21.

The two-dimensional display 11c displays the two-dimensional image data generated by the two-dimensional video generating unit 11b on a screen as a two-dimensional image. The display unit 11 may acquire, from the projection unit 12, any one of the two types of two-dimensional image data for the left and right eyes generated by the VR video generating unit 15a of the VR goggle 15, and display the data on the two-dimensional display 11c.

The user operation unit 11d is a device capable of receiving various button operations and coordinate input operations by a user, such as a mouse or a keyboard which is a general input device. In the present embodiment, the user operation unit 11d can receive input operations by the participants P12 to P42. Specifically, the user operation unit 11d can perform a correction instruction such as change, addition, or deletion to the movement or the like of a user designated part in the stereoscopic image 21 of the VR examination place 20 displayed on a screen of the two-dimensional display 11c. In addition, the user operation unit 11d receives designation of a position on the screen of the two-dimensional display 11c as an input operation by each participant P12 to P42. The user operation unit 11d calculates a clicked position on the screen of the two-dimensional display 11c. The calculated position information is transmitted to the conferencing management server 30 via the communication device 11a. As will be described later, a dart pointer is generated at a designated position and reflected in the stereoscopic image 21 based on the process in the conferencing management server 30.

The voice transmission unit 11e can transmit, to another site via the communication device 11a and the communication network 25, information on voice uttered by a participant taken in from a microphone of the head set 17. Further, the voice transmission unit 11e can receive information on voice uttered by an examiner or a participant at each of the other sites via the communication network 25 and the communication device 11a, and output the information as a voice from a speaker of the head set 17.

### <Operation of System>

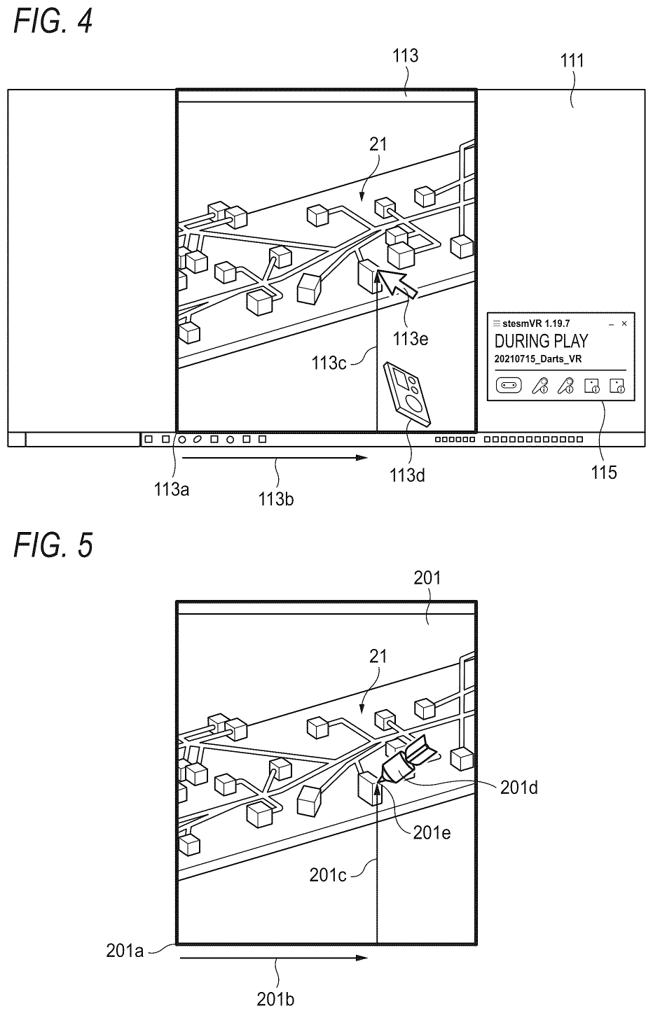

An operation example of the VR conferencing system 100, in particular, a process example of displaying a dart pointer will be described with reference to FIGS. 4 to 6.

The VR data generating unit 35 on the conferencing management server 30 generates three-dimensional data of the stereoscopic image 21 in the VR space of the VR examination place 20 based on the design data of the wire harness held by the database management unit 33. For each of the avatars A11 to A41 managed by the avatar control unit 36, the VR data generating unit 35 also generates three-dimensional data of the stereoscopic image 21 in the VR space of the VR examination place 20.

When the online conference is started using the VR conferencing system 100, the projection unit 12 worn by the examiners P11 to P41 at the sites and the display unit 11 used by the participants P12 to P42 are connected to the conferencing management server 30 via the communication network 25 so that the projection unit 12, the display unit 11, and the conferencing management server 30 can communicate with each other.

The projection unit 12 at each site acquires the data of the stereoscopic image 21 in the VR examination place 20 generated by the VR data generating unit 35 of the conferencing management server 30, performs coordinate conversion of the data to be a stereoscopic image shown in the field of view of each of the right and left eyes of each of the examiners P11 to P41, and projects the stereoscopic image so that the respective examiners P11 to P41 can visually recognize the stereoscopic image by the VR goggle 15. Video (visible region) visible to each of the examiners P11 to P41 in the VR goggle 15 is determined for each VR goggle 15.

Further, the display unit 11 at each site acquires the data of the stereoscopic image 21 in the VR examination place 20 generated by the VR data generating unit 35 of the conferencing management server 30, performs coordinate conversion of the data to substantially match a stereoscopic image shown in the field of view of each of the examiners P11 to P41 in the same site, and displays the data on the screen of the two-dimensional display 11c.

FIG. 4 shows an example of a display screen 111 of the display unit 11 at the site H1. The display screen 111 is generated by the two-dimensional video generating unit 11b and includes a VR screen 113 and a VR operation screen 115. The VR operation screen 115 is a screen for inputting an operation such as tool selection to the VR screen 113. For example, when a dart pointer mode is selected on the VR operation screen 115, an icon 113d is displayed on the VR screen 113, and the dart pointer 201d (see FIG. 5) can be displayed. The VR screen 113 is a two-dimensional image obtained by performing coordinate transformation to substantially match a stereoscopic image captured in the field of view of the examiner P11 projected by the projection unit 12 at the site H1. The two-dimensional video generating unit 11b fixes a size of the VR screen 113 in a region seen by the VR goggle 15 at the site H1. If the size of the VR screen 113 is not fixed, when the size of the VR screen 113 is changed, the video is different from the video captured in the field of view of the examiner P1, and a part thereof is cut off.

When each of the examiners P11 to P41 moves in the reality space or changes the posture or the line of sight while visually recognizing the stereoscopic image projected from the VR goggle 15, the change is detected by the user position detection unit 12b and the user posture detection unit 15d. The change in the posture and the line of sight of each of the examiners P11 to P41 in the reality space is reflected in the change of the field of view in the VR examination place 20 of the examiner.

The VR video generating unit 15a of the VR goggle 15 updates the stereoscopic image to be projected on the left-eye display 15b and the right-eye display 15c in accordance with the change in the field of view of the examiner. In addition, the two-dimensional video generating unit 11b of the display unit 11 updates the image displayed on the two-dimensional display 11c so as to follow the change in the field of view of the examiner present at the same site. The display size of the image is fixed.

By operating the user operation unit 12c, the examiners P11 to P41 at the respective sites can change a part of interest of a stereoscopic image shown in his or her field of view as necessary. For example, it is possible to change a shape of a part of interest of the wire harness, move a position at which each jig is disposed, and add or delete a component or a jig of the wire harness.

The participants P12 to P42 at the respective sites can inform the examiners P11 to P41 and the other participants P12 to P42 of the place of interest by operating the user operation unit 11d. For example, as shown in FIG. 4, when the participant P12 positions a mouse pointer 113e at the place of interest on the VR screen 113 and clicks a mouse, a position on the VR screen 113 is input as a designated position.

A correction input by an input operation of the examiners P11 to P41 at the respective sites and a designated position input by an input operation of the participants P12 to P42 at the respective sites are input from the projection unit 12 and the display unit 11 to the conferencing management server 30 via the communication network 25. The change control unit 37 of the conferencing management server 30 receives the correction input from each of the examiners P11 to P41 and the designated position input from each of the participants P12 to P42, and records the contents thereof as update data in the database management unit 34.

For example, as shown in FIG. 4, when the designated position is input from the participant P12, the user operation unit 11d sets a lower left corner of the VR screen 113 whose size is fixed as a reference point 113a, and calculates the position clicked with the mouse. The user operation unit 11d calculates an X-coordinate position 113b in a right direction from the reference point 113a and a Y-coordinate position 113c in an upward direction from the reference point 113a, and obtains the position information of the designated position. The calculated position information is input from the communication device 11a to the conferencing management server 30 via the communication network 25, and is recorded in the database management unit 34 as update data.

When the VR data generating unit 35 of the conferencing management server 30 detects that new update data is added to the database management unit 34, the VR data generating unit 35 generates new data of the stereoscopic image 21 by reflecting the correction contents of the update data in the stereoscopic image 21 of the VR examination place 20 generated by the VR data generating unit 35. When the designated position is input from the display unit 11, the VR data generating unit 35 acquires data of at least a position of the VR goggle 15 worn by the examiner P11 and sets the acquired data as a start position of the dart pointer. The VR data generating unit 35 sets the position information recorded in the database management unit 34 as a goal position, and generates data of the stereoscopic image 21 with respect to the dart pointer in a form of reaching the goal position from the start position toward the goal position.

The communication device 31 of the conferencing management server 30 transmits, to each of the system equipment 10A to 10D at the respective sites H1 to H4, the corrected data of the stereoscopic image 21 generated by the VR data generating unit 35.

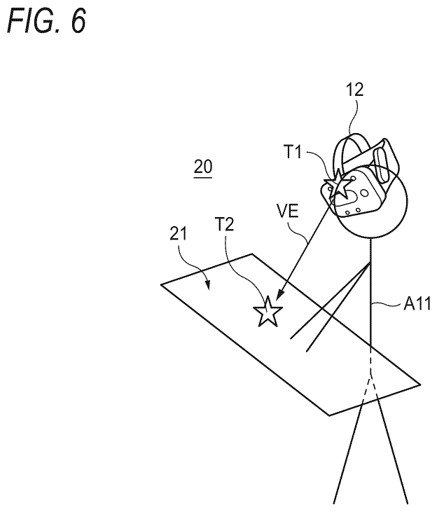

The projection unit 12 at each site acquires the data of the corrected stereoscopic image 21 transmitted from the conferencing management server 30, performs coordinate conversion of the data to be a stereoscopic image shown in the field of view of each of the right and left eyes of each of the examiners P11 to P41, and projects the stereoscopic image so that the respective examiners P11 to P41 can visually recognize the stereoscopic image by the VR goggle 15. For example, the projection unit 12 at the site H1 projects the stereoscopic image 201 shown in FIG. 5 as an example. In the stereoscopic image 201 in FIG. 5, the dart pointer 201d is displayed for disposing a tip at a position 201e. The position 201e is a position where an X coordinate position 201b and a Y coordinate position 201c correspond to the X coordinate position 113b and the Y coordinate position 113c shown in FIG. 4, respectively, with a lower left corner as a reference point 201a. For example, as shown in FIG. 6, the dart pointer 201d is drawn such that a position of the avatar A11 in the VR examination place 20, that is, a position of the VR goggle 15 is set as a start position T1, and the tip is disposed at a goal position T2 along a vector VE toward the goal position T2. The dart pointer 201d is an example of a pointer.

The display unit 11 at each site acquires the corrected data of the stereoscopic image 21 transmitted from the conferencing management server 30, performs coordinate conversion of the data to substantially match a stereoscopic image shown in the field of view of each of the examiners P11 to P41 in the same site, and displays the data on the screen of the two-dimensional display 11c.

Therefore, by using the VR conferencing system 100 shown in FIGS. 2 and 3, as shown in FIG. 1, all of the examiner P11 and the participant P12 at the site H1, the examiner P21 and the participant P22 at the site H2, the examiner P31 and the participant P32 at the site H3, and the examiner P41 and the participant P42 at the site H4 can hold an online conference using the virtual reality space of the common VR examination place 20 without moving.

In particular, the examiners P11 to P41 can stereoscopically recognize the stereoscopic image 21 projected by the VR goggle 15 in the same manner as a real object, and the movement and posture change of the examiners P11 to P41 are reflected in the fields of view of the examiners P11 to P41 in the space of the VR examination place 20, and thus it is easy to confirm in detail a three-dimensional shape and structure of a part required to be examined.

In addition, since the avatars A11 to A41 corresponding to the examiners P11 to P41 at the respective sites are included in the stereoscopic image 21 in the VR examination place 20, the examiners P11 to P41 can also recognize a part on the wire harness, a direction of a line of sight, and the like confirmed by other examiners. That is, the examiners P11 to P41 can easily grasp a relative positional relation or the like between the examiners while being present at sites of different places, and thus it is possible to efficiently perform an operation of confirming a common target part on the stereoscopic image 21 by all the examiners as in the case of holding a conference in a common reality space.

Further, the examiners P11 to P41 at the respective sites can perform a correction operation such as change, addition, or deletion on the stereoscopic image 21 by performing an input operation as necessary. In addition, by reflecting a result of the correction operation on the content of the projected stereoscopic image 21, the examiners P11 to P41 at the respective sites can easily grasp a three-dimensional shape and a structure of the corrected stereoscopic image 21.

In addition, the participants P12 to P42 at the respective sites can confirm a two-dimensional image in substantially the same range as the stereoscopic image 21 reflected in the field of view of the examiners P11 to P41 at the same site on the screen display of the display unit 11. Therefore, even in a case where there is no real model or the like in each of the venues V1 to V4, the participants P12 to P42 also easily grasp a shape and structure of the part to be examined, similarly to the examiners P11 to P41.

In particular, in the VR conferencing system 100, when the participants P12 to P42 designate a position on a screen of the display unit 11 by a mouse operation or the like, the dart pointer 201d is displayed at a position of the corresponding stereoscopic image 21. Accordingly, since the participants of an online conference can share the place of interest, smooth communication is possible.

The present invention is not limited to the embodiment described above and can be appropriately modified, improved and the like. Materials, shapes, sizes, numbers, arrangement positions, and the like of components in the embodiment described above are freely selected and are not limited as long as the present invention can be implemented.

For example, in the above-described embodiment, it is assumed that an online conference is held using the VR conferencing system 100 to examine the design of a wire harness for an automobile at the plurality of sites. Not only the wire harness but also various types of products can be disposed as the stereoscopic image 21 in the VR examination place 20 to be examined.

When a function equivalent to that of the conferencing management server 30 is installed in any of the system equipment 10A to 10D at the plurality of sites, the conferencing management server 30 may be omitted. For example, when a function equivalent to the conferencing management server 30 is mounted on the projection unit 12 of the system equipment 10A, the display unit 11 may receive designation of a position by the user operation unit 11d and transmit the calculated position information to the projection unit 12 via the communication device 11a. The dart pointer 201d is generated and reflected in the stereoscopic image 21 by the process in the projection unit 12.

Further, the display units 11 disposed at the respective sites H1 to H4 respectively display the fields of view of the examiners P11 to P42 at the respective sites H1 to H4. The participants P12 to P42 at the respective sites H1 to H4 may be configured to be able to select which field of view of the examiners P11 to P41 is displayed on the screen of each display unit 11. That is, each display unit 11 can display, on the screen, the field of view of the selected examiner among the examiners P11 to P41 at any of the sites H1 to H4. For example, when the participant P12 selects the field of view of the examiner P21, an image of the VR examination place 20 in substantially the same range as a video captured in the field of view of the examiner P21 is displayed on the screen of the display unit 11 at the site H1 via the conferencing management server 30. When the participant P12 designates a position on the screen, the projection unit 12 of the examiner P21 can display the dart pointer 201d in a form of reaching the designated position from a position of the projection unit 12 of the examiner P21 to the designated position in the VR examination place 20. The display of the dart pointer 201d is reflected in the contents of the fields of view of the other examiners P11, P31, P41 in real time, and is also reflected on the display contents of the display unit 11 at the other sites H2, H3, H4.

Here, features of the virtual reality conferencing system according to the above-described embodiment of the present invention are briefly summarized and listed in the following [1] to [3]. [1] A communication system (the VR conferencing system 100) includes:
a first electronic device (the projection unit 12); and
a second electronic device (the display unit 11) capable of communicating with the first electronic device, in which
the first electronic device includes a first display unit (the VR goggle 15) that displays an object (the stereoscopic image 21) edited in accordance with a user operation in a virtual reality space,
the second electronic device includes:
   a second display unit (two-dimensional display 11c) configured to display a field of view (the VR Screen 113) by the first display unit of the first electronic device; and
   a position designation unit (the user operation unit 11d) configured to receive designation of a position on a screen of the second display unit, and
the first display unit displays a pointer (the dart pointer 201d) at a position in the virtual reality space corresponding to the position.

The second electronic device calculates position information of the position received by the position designation unit in the second display unit and transmits the position information to the first electronic device, and
the first electronic device sets a position based on the position information in the virtual reality space as a goal position, sets a position of the first electronic device in the virtual reality space as a start position, and displays, in the virtual reality space, the pointer formed in a dart shape in which a tip is disposed at the goal position along a vector from the stat position toward the goal position.

According to the communication system having a configuration of [1], when the position is designated on the second display unit of the second electronic device, the pointer is displayed on the first display unit of the first electronic device. Accordingly, since a person who views the second display unit of the second electronic device and a person who views the first display unit of the first electronic device can share a place of interest, smooth communication is possible. Further, since the pointer is displayed ahead of a line of sight of the person who views the first display unit in the virtual reality space, and the line of sight is guided to the goal position, the person who views the first display unit can easily grasp the place of interest.

[2] The communication system according to [1], in which
a size of the field of view displayed on the second display unit by the first display unit is fixed.

According to the communication system having a configuration of [2], since the size of the field of view by the first display unit displayed on the second display unit is fixed, the second display unit can display an image equivalent to the field of view of the first display unit without cutting a part of the field of view of the first display unit.

[3] The communication system according to [2], in which
the second electronic device calculates position information of the position received by the position designation unit in the second display unit and transmits the position information to the first electronic device, and
the first electronic device sets a position based on the position information as a goal position of the pointer, sets a position of the first electronic device in the virtual reality space as a start position, and displays, in the virtual reality space, the pointer in a form of reaching the goal position from the start position toward the goal position.

According to the communication system having a configuration of [3], since the pointer is displayed ahead of a line of sight of the person who views the first display unit in the virtual reality space, and the line of sight is guided to the goal position, the person who views the first display unit can easily grasp the place of interest.

The present application is based on a Japanese patent application (Japanese Patent Application No. 2022-052163) filed on Mar. 28, 2022, and the contents thereof are incorporated herein by reference.

### INDUSTRIAL APPLICABILITY

The present invention is useful for a conferencing system using a virtual reality space.

What is claimed is:

1. A communication system comprising:
a first electronic device; and
a second electronic device that communicates with the first electronic device, wherein
the first electronic device includes a first display unit that displays an object edited in accordance with a user operation in a virtual reality space,
the second electronic device includes:
a second display unit configured to display a field of view by the first display unit of the first electronic device; and
a position designation unit configured to receive designation of a position on a screen of the second display unit,
the first display unit displays a pointer at a position in the virtual reality space corresponding to the position,
the second electronic device calculates position information of the position received by the position designation unit in the second display unit and transmits the position information to the first electronic device, and
the first electronic device sets a position based on the position information in the virtual reality space as a goal position, sets a position of the first electronic device in the virtual reality space as a start position, and displays, in the virtual reality space, the pointer formed in a dart shape in which a tip is disposed at the goal position along a vector from the stat position toward the goal position.

2. The communication system according to claim 1, wherein
a size of the field of view displayed on the second display unit by the first display unit is fixed.
